(19) United States
(12) Patent Application Publication
(10) Pub. No.: US 2005/0059565 A1
(43) Pub. Date: Mar. 17, 2005

(54) Cleaning composition

(76) Inventors: David C. Sutton, Racine, WI (US); Lance D. Brown, Racine, WI (US); William Y. Keng, Alpharetta, GA (US); Thomas Reynolds, New South Wales (AU)

Correspondence Address: JOHNSONDIVERSEY, INC.;Patent Section - M.S. 509, 8310 16TH Street, P.O. Box 902, Sturtevant, WI, 53177-0902, US

(21) Appl. No.: 10/932,166

(22) Filed: Sep. 1, 2004

Related U.S. Application Data
(60) Provisional application No. 60/499,905, filed on Sep. 3, 2003.

(51) Int. Cl. C11D 1/00

(52) U.S. Cl. 510/218

(57) ABSTRACT

A cleaning composition is provided comprising a solvent system and at least one inorganic alkaline salt, wherein the solvent system includes at least one polyhydric alcohol. The inventive composition may also include a thickener, a corrosion-inhibition system, surfactant. The invention also provides a method of cleaning soil from a cooking related surface comprising, applying a cleaning composition to the surface, allowing the cleaning composition to remain on the surface for a period of time and removing the composition from the surface along with the soil. After application of the composition, the surface can be heated prior to removal of the composition and soil from the surface.

### BACKGROUND OF THE INVENTION

The present invention relates generally to a composition for cleaning hard surfaces, in particular, it relates to products and methods suitable for the removal of cooked-, baked-, and burned-on soils from cooking related surfaces, including cookware, tableware, grills, ovens, baking pans, bakery carts, etc. and other metallic or ceramic cooking/baking surfaces which have carbonized soils thereon.

Cooked-, baked-, and burned-on soils are among the most severe types of soils to remove from surfaces. Traditionally, the removal of such cooked-, baked and burned-on soils from cooking related surfaces requires soaking the soiled surface prior to a mechanical action. The automatic dishwashing process alone has not provided a satisfactory solution for removal of such soils. Manual cleaning processes require a tremendous amount of mechanical action or “elbow grease” to remove such cooked-, baked-, and burned-on soils. Additionally, such mechanical action can be detrimental to the safety and condition of the surface being cleaned.

Acidic and alkaline cleaning compositions for hard surfaces have been used for many years to remove stubborn soils from a variety of surfaces found in household and institutional locations. Such soils include inorganic soils and soils derived from organic sources, such as fats, oils, proteins and carbohydrates. Such soils when heated, can form hard, tenacious deposits on a variety of surfaces including ceramic, stainless steel, tile and metal food preparation surfaces. Typical inorganic solids comprising insoluble materials derived from the hardness component of consumer and commercial water, include substantially insoluble salts of calcium, magnesium, iron, manganese, etc. such inorganic salts can be combined in some cases with organic residues which can form large, difficult to remove soil deposits. These soils can be unsightly, can take the form of large deposits of charred or baked-on residue, or large areas of white insoluble soap scum or hardness deposits. Additionally, these soils can also promote or support the growth of microorganisms that can, under certain circumstances, contaminate food or other contaminatable materials or surfaces. Such promotion of microorganism growth can result in health code violations for institutional operations and potential food contamination in both commercial and residential/consumer environments. Additionally such soils can lead to uneven cooking or baking.

Previously, it has been common to clean such items and remove such soil by utilization of long soak times, corrosive agents and a large degree of mechanical action. Unfortunately these previous compositions resulted in unsatisfactory removal of soils. Additionally, these previous compositions have contained odiferous solvents and other odor-causing materials. A large degree of mechanical action was also frequently required. Length of time and the associated cost is also a concern especially in an institutional environment where a reduction in labor cost is critical. Also, over time conventional cleaners, because of their corrosive nature, deteriorate or damage the cooking related surfaces. Further, as a cooking related surface became more soiled without successful removal of such soil, it became commonplace to discard the soiled surface/object and replace it, thus, resulting in additional cost.

In summary, a considerable number of deficiencies exist in the art relating to hard surface cleaners—in particular for cleaning of cooking related surfaces such as cookware, tableware, bakery carts, baking pans, grills, ovens, etc., and other metallic or ceramic cooking/baking surfaces containing carbonized soils. Indeed, there is still a need for an effective, efficient cleaning composition and method of use prior to the washing process of tableware and cookware soiled with cooked-on, baked-on or burned-on soils in order to facilitate the removal of these stubborn residues. Further, the facilitation of removal of these stubborn residues or soils in a non-corrosive or minimally-corrosive environment is desirable.

Accordingly, it is an object of the present invention to provide a cleaning composition wherein said composition provides good performance on the removal of baked-on, polymerized soils, preferably polymerized grease soil from metal and other substrates while reducing the odor of such composition and its corrosiveness. In particular, there is a need for an improved cleaning composition, which overcomes the shortcomings of the compositions of the prior art.

### SUMMARY OF THE INVENTION

One aspect of the invention provides a composition for cleaning soil from a cooking related surface. The cleaning composition comprising a solvent system and at least one inorganic alkaline salt. The solvent system comprises at least one polyhydric alcohol. Other optional components include water, a thickener, a corrosion-inhibition system, and surfactant.

The cleaning composition of the present invention includes a solvent system comprising at least one polyhydric alcohol. Typically, the solvent system can comprise about 050 to 98.5 weight percent of the cleaning composition. Such a solvent system acts as a carrier and assists in dissolving and softening the baked-on soil or residue and suspends such soil or residue until it is washed from the surface. In some embodiments, the solvent system comprises about 20.0 to 80.0 weight percent of the cleaning composition. In some embodiments, the solvent system is about 40.0 to 50.0 weight percent of the cleaning composition. In one embodiment the polyhydric alcohol is an alkane polyol having from 2 to 6 carbon atoms and from 2-3 hydroxyls in the molecule. Suitable polyhydric alcohols include ethylene glycol, propylene glycol, dipropylene glycol, glycerin, 1,2-Butanediol, 1,3-Butanediol, 1,4-Butanediol, 2,3-Butanediol, 1,2-Propanediol, 1,5-Pentanediol, meso-erythritol, neopentyl glycol, pentaerythritol, and blends thereof. The solvent system can also optionally include water.

The inventive cleaning composition also includes at least one inorganic alkaline salt. Such inorganic alkaline salt provides for a caustic material which is useful in saponifying cooking oils and greasy soils from baked-on soil. Such inorganic alkaline salt can be present in the composition in an amount of about 0.10 to about 10.0 weight percent of the composition. In alternative embodiments the inorganic alkaline salt is about 0.10-3.0 weight percent of the composition. In some embodiments, such inorganic alkaline salts comprise about 1.0 to 3.0 weight percent of the composition. In other embodiments, such inorganic alkaline salts comprise about 1.0 to 2.0 weight percent of the composition. Suitable inorganic alkaline salts are selected from the group consisting of lithium carbonate, potassium carbonate, sodium carbonate, lithium hydroxide, potassium hydroxide, sodium hydroxide, lithium silicates, sodium silicates, potassium silicates, lithium phosphates in all forms, sodium phosphates, potassium phosphates, and combinations thereof.

In one embodiment, the cleaning composition also includes a thickener which improves contact of the cleaning composition on the surface to be cleaned, and in particular vertical surfaces to be cleaned. If heat is to be applied in the cleaning method, any clay or natural based inorganic thickener can be utilized. However, if heat is not to be utilized in the method of cleaning, any thickener known to one of ordinary skill in the art can be utilized. The thickener can comprise approximately 0.10 to 6.0 weight percent of such a cleaning composition. Some embodiments of the cleaning composition include about 1.0 to 5.0 weight percent of a thickener. In alternative embodiments the thickener is about 2.0 to 4.0 weight percent of the composition.

Further, the inventive cleaning compositions may include a corrosion inhibition system. Such a corrosion inhibition system is useful in preventing damage to the surface being cleaned, and, in particular, a metallic cooking/baking pan, carts, grills and oven surfaces, which are oftentimes aluminum. Such a corrosion inhibition system is present in an amount of about 0.50 to 5.0 weight percent of the cleaning composition. In some embodiments, the corrosion inhibition system comprises about 1.0 to 4.0 weight percent of the composition. In alternative embodiments of the cleaning compositions, the corrosion inhibition system is present in about 2.0 to 3.0 weight percent of the cleaning composition.

Typically, the corrosion inhibition system comprises sodium silicates and triazoles. These components are present in a ratio of approximately 10:1 to 50:1. In some embodiments, the ratio of sodium silicates to triazoles is 20:1 to 40:1. The ratio of sodium silicates to triazoles is about 30:1 in some embodiments.

Such cleaning compositions have been found to effectively remove a significant amount of baked-on, cooked-on and burned-on soil from metallic, glass, ceramic, etc. cooking related surfaces, including, cookware, tableware, bakery carts, baking pans, grills, and ovens—used in both institutional and consumer settings. Of particular benefit is that the inventive composition is non-corrosive or only minimally corrosive to cooking related surfaces. The inventive compositions are applied to such cooking related surface to be cleaned by any number of techniques including, for example, pouring, spraying, sprinkling, brushing, immersing, etc. the inventive cleaning composition onto the cooking related surface of the item to be cleaned. The cleaning composition is then either allowed to stand for a period of time, or heated for a period of time. After such standing or heating, the surface or item to be cleaned is then washed in a usual manner which can involve handwashing, spraying, automatic dishwashing, etc. The thus cleaned cooking related surface is then allowed to dry or is wiped dry.

In one embodiment, the inventive method for utilization of such a composition for cleaning soil from cooking related surfaces comprises applying the cleaning composition to a surface or item to be cleaned by, for example spraying, dipping, pouring, brushing, etc. The next step involves allowing the cleaning composition to remain on the surface for a period of time. The composition is then removed from the surface along with the soil by, for example, washing or flushing with water. Washing can occur, for instance, in an automatic dishwasher, by manual action, spraying or dipping to remove the cleaning composition and the softened cooking residue or soil. The cleaning composition can be applied to the surface to be cleaned and left to stand for a period of about 20-200 minutes. In one embodiment, the method includes heating the surface to about 100° to 400° F. for about 20-60 minutes after the cleaning composition has been applied to the surface. Likewise then, the composition is removed. Again, washing in an automatic dishwasher, manual washing, spraying, dipping, etc. can be utilized to remove the cleaning composition and the softened cooking residue or soil.

### BRIEF DESCRIPTION OF THE DRAWINGS

FIG. 1 is a picture of a soiled bakery cart prior to utilization of the inventive composition and method.

FIG. 2 is a picture the bakery cart of FIG. 1 after utilization of the inventive composition and method to remove the soil.

FIG. 3 is a picture of another soiled bakery cart prior to utilization of the inventive composition and method.

FIG. 4 is an exploded picture of a portion of the soiled bakery cart of FIG. 3.

FIG. 5 is a picture of the bakery cart of FIGS. 3 and 4 after utilization of the inventive composition and method.

### DETAILED DESCRIPTION OF THE PREFERRED EMBODIMENT

The present invention is directed to an improvement in compositions for cleaning hard surfaces—namely, compositions for cleaning of metallic, glass, ceramic, etc. cooking related surfaces which are soiled with cooked-on, baked-on or burned-on soil. The cleaning compositions of the present invention include a solvent system and at least one inorganic alkaline salt. Optional components include a thickener, a corrosion-inhibition system, surfactant and water.

Preferably, the cleaning composition has a viscosity of about 2,000 to 10,000 cps. Such viscosity range results in the cleaning composition having sufficient contact time or “cling” to the soiled cooking related surface while maintaining its processability and allowing for various application techniques.

The inventive compositions have been found to be less corrosive or non-corrosive to cooking related surfaces, in particular those including an aluminum component, than conventional cleaning compositions for such cooking related surfaces. Utilization of the inventive composition results in a significant reduction in corrosion to the cooking related surfaces during removal of carbonized soils and other cooked-on, baked-on and burned-on soils and deposits. As those soils described in the Background of the Invention.

Previously, corrosion of cooking related surfaces has been commonplace when attempts to remove soil from such surfaces have been made in the past. Corrosion is commonly defined as the gradual electrochemical disintegration or decomposition of a material. The corrosion of cooking related surfaces, which are oftentimes metal, and in particular aluminum, is evidenced by any number of occurrences depending on the speed and extent with which such corrosion occurs. Corrosion can be evidenced by the evolution of gas from the surface, slow discoloration or dulling from a shiny appearance to a dull white grey appearance, to a complete disintegration or break down of the surface. “Non-corrosive” as used herein means that, as related to typical cooking related surfaces, the composition does not result in evolution of gas from the surface, does not discolor or dull the surface from a shiny appearance to a dull white grey appearance, does not disintegrate or break down the surface. The inventive composition typically exhibits no corrosive activity or minimal corrosive activity toward typical cooking related surfaces.

Solvent systems of the present invention include at least one polyhydric alcohol. The miscible polyhydric alcohols which are useful in the present invention are preferably miscible alkane polyols having from 2-6 carbon atoms and from 2-3 hydroxyls in the molecule. Examples of suitable polyhydric alcohols include ethylene glycol, propylene glycol, dipropylene glycol, glycerin, 1,2-Butanediol, 1,3-Butanediol, 1,4-Butanediol, 2,3-Butanediol, 1,2-Propanediol, 1,5-Pentanediol, meso-erythritol, neopentyl glycol, pentaerythritol, and blends thereof. Such a solvent system can also optionally include water.

The solvent system comprises about 0.50 to about 98.5 weight percent of the cleaning composition. In some embodiments, the solvent system comprises about 20.0 to 80.0 percent of the cleaning composition. Such a solvent system acts to help dissolve and soften the baked-on cooking residues that enable potential other ingredients to act and keep residue suspended until the residue is removed from the surface. Further, it is believed that the solvent system enhances the activity of the inorganic alkaline salt by keeping the composition “wet” on the cooking related surface to be cleaned.

The inventive composition also includes at least one inorganic alkaline salt. Such salt typically comprises about 0.10 to 10 weight percent of the cleaning composition. In some embodiments, the inorganic alkaline salt is about 0.10 to 3.0 weight percent of the composition. In some embodiments of the compositions, such salts are present at about 1.0 to about 2.0 weight percent. Inorganic alkaline salts can include lithium carbonate, potassium carbonate, sodium carbonate, lithium hydroxide, potassium hydroxide, sodium hydroxide, lithium silicates, sodium silicates, potassium silicates, lithium phosphates in all forms, sodium phosphates, potassium phosphates, and combinations thereof are all suitable for use in the present composition. All forms of such salts are suitable for use including various hydration grades, mono-, di-, tri-, ortho- and pyro-forms. Additional useful inorganic alkaline salts include citrates, and polyphosphates, e.g. sodium tripolyphosphate and sodium tripolyphosphate hexadydrate, potassium tripolyphosphate and mixed sodium and potassium tripolyphosphate salts; and partially water-soluble or insoluble salts such as crystalline layered silicates (EP-A-0164514 and EP-A-0293640) and aluminosilicates inclusive of Zeolites A, B, P, X, HS and MAP. In one embodiment it has been found useful to utilize potassium hydroxide. Potassium hydroxide can be utilized in various forms including a 45 percent solution, solid pellet and flakes, as can other inorganic alkaline salts.

The inventive composition can also include a thickener or thickening agent. Suitable thickening agents for use herein include viscoelastic, thixotropic thickening agents at levels of from about 0.10-10 weight percent of the cleaning composition, preferably from about 0.25-5.0 weight percent, most preferably from about 2.0-4.0 weight percent of the composition. Suitable thickening agents include polymers with a molecular weight from about 500,000 to about ten million and, more preferably from about 750,000 to about four million. The preferred cross-linked polycarboxylate polymer is preferably a carboxy vinyl polymer. Such compounds are disclosed in U.S. Pat. No. 2,798,053 issued on Jul. 2, 1957 to Brown. Methods for making carboxy vinyl polymers are also disclosed in Brown. Carboxy vinyl polymers are substantially insoluble in liquid, volatile organic hydrocarbons and are dimensionally stable upon exposure to air.

Other suitable thickening agents include inorganic clays (i.e. laponites, aluminum silicate, bentonite, fumed silica). A preferred clay thickening agent can be either naturally occurring or synthetic. Preferred synthetic clays include the synthetic smectite-type clay sold under the trademark Laponite by Southern Clay Products, Inc. Particularly useful are gel-forming grades such as Laponite RD and sol-forming grades such as Laponite RDF. Natural occurring clays include some smectite and attapulgite clays. Mixtures of clays and polymeric thickeners are also suitable for use herein. Preferred for use herein are synthetic smectite-type clays such as Laponite and other synthetic clays having an average platelet size maximum dimension of less than about 100 nm. Laponite has a layered structure which in dispersion in water, is in the form of disk-shaped crystals of about 1 nm thick and about 25 nm diameter. Small platelet size is valuable herein for providing a good sprayability, stability, reality and cling properties as well as desirable aesthetics.

Other types of thickeners which can be used in this composition include natural gums, such as xanthan gum, locust bean gum, guar gum, and the like. The cellulosic-type thickeners: hydroxy, ethyl and hydroxy methyl cellulose (ETHOCEL® and METHOCEL®) available from Dow Chemical) can also be used. Natural gums seem to influence the size of the droplets when the composition is being sprayed. It has been found that various combinations and levels of thickener can produce the desired sprayability, cling, stability and soil penetration performance. A highly preferred thickener includes veegum granules which are spray-dried smectite clay that upon hydration form such platelets and evenly disperse through the solution.

Further, depending on the method utilized, and in particular, inclusion of a baking or heating step post-cleaning composition application, but prior to a washing step, careful selection of a thickener must be made. In particular, where heat is utilized, a clay or material inorganic thickener is more suitable. Other types of thickeners tend to polymerize and increase the soil thereon. One of ordinary skill in the art would readily understand this and appropriately select thickeners for use in a particular method.

The inventive composition can also include a corrosion inhibition system. Such a corrosion inhibition system typically includes a combination of components, and in particular, sodium silicates and a triazole. Suitable sodium silicates include anhydrous sodium metasilicate, sodium metasilicate pentahydrate, sodium silicate and sodium silicate solutions. Preferably, sodium metasilicate pentahydrate has been found to be preferable for use in the corrosion inhibition system. Suitable triazoles include Cobratec PT, Cobratec TT-505C, Cobratec TT-85, Cobratec TT-100 and Cobratec 99. In particular 2-methyl benzotriazole has proven to be beneficial. 2-methyl benzotriazole is available under the name Cobratec 99 from PMC Specialties Group, Inc., Div. of PMC, Inc.

In one embodiment it has been bound beneficial to use a corrosion inhibition system including silicate in order to prevent damage to aluminum and some painted surfaces. Amorphous sodium silicates having an SiO₂;Na₂O ratio of from 1.8 to 3.0, preferably from 1.8 to 2.4, most preferably 2.0 can also be used herein although highly preferred from the viewpoint of long term storage stability are compositions containing less than about 22%, preferably less than about 15% total (amorphous and crystalline) silicate.

Preferably, the corrosion inhibition system is about 0.50-5.0 weight percent of the cleaning composition. Some embodiments include about 1.0-4.0 weight percent of a corrosion inhibition system. Alternative embodiments of the composition include about 2.0-3.0 weight percent of a corrosion inhibition system. If a combination of sodium silicates and triazoles is utilized, the ratio of sodium silicates to triazoles is about 10:1 to 50:1. Some systems including 20:1 to 40:1. Some embodiments of the inventive composition include a ratio of 30:1 of sodium silicate to triazole. Such a corrosion inhibition system provides a cleaning composition which exhibits no corrosive or minimal corrosive activity toward a surfaces being cleaned, in particular, aluminum surfaces which are commonly found in such cooking related surfaces, in particular, bakeware, cookware and tableware items.

Further, the inventive compositions can also include surfactants in varying amounts which improve rinseability of the product in the later stages of the cleaning process. Such water rinseability is improved because such surfactants lower surface tension and increase wetability. Various anionic, nonionic and amphoteric surfactants have been found useful in the cleaning compositions of the present invention.

Suitable nonionic surfactants can be broadly defined as compounds produced by the condensation of alkylene oxide groups (hydrophilic in nature) with an organic hydrophobic compound, which may be aliphatic or alkyl aromatic in nature. The length of the hydrophilic or polyoxy alkylene radical which is condensed with any particular hydrophobic group can be readily adjusted to yield a water-soluble compound having the desired degree of balance between hydrophilic and hydrophobic elements.

Suitable anionic surfactants can be broadly described as the water-soluble salts, particularly the alkali metal salts, of organic sulfur reaction products having in their molecular structure an alkyl radical containing from about 8 to about 22 carbon atoms and a radical selected from the group consisting of sulfamic acid and sulfuric acid esteradicals. Such surfactants are well known in the art and are described at length in Surface Active Agents and Detergents, Vol. II by Schwartz, Perry and Berch, Interscience Publishers Inc., 1958, incorporated by reference herein.

Among the useful anionic compounds are the higher alkyl sulfates, the higher fatty acid monoglycerites sulfates, the higher alkyl sulfonates, the sulfated phenoxy polyethoxy ethanols, the branched higher alkyl benzene sulfonates, the higher linear olefin sulfonates (i.e. hydroxy alkane sulfonates and alkenyl sulfonates, including mixtures thereof), higher alkyl ethoxomer sulfates and methoxy higher alkyl sulfates, such as those of the formula RO(C₂H₄O)nSO₃M, wherein R is a fatty alkyl of 12-18 carbon atoms, and n is from 2-6 and M is a soluble salt-forming cation, such an alkali metal and (formula—see col. 5 '039 patent) wherein R¹ and R² are selected from the group consisting of hydrogen and alkyls, with the total number of carbon atoms in R¹ and R² being in the range of 12-18, and x and y are selected from the group consisting of hydrogen, alkyls from C₁ to C₂₀ and alkali metals and mixtures thereof.

The detergent surfactant is preferably foamable in direct application but low foaming in automatic dishwashing use. Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C_{20′}, preferably C₁₀-C₁₈ linear or branched; low and high cloud point nonionic surfactants and mixtures thereof including nonionic alkoxylates surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC® and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/00874. Surfactants are typically present at a level of from about 0.02 percent to about 30.o weight percent, more preferably from about 0.05 percent to about 10.0 weight percent, most preferably from about 1 percent to about 5.0 weight percent of composition. Preferred surfactants for use herein are low foaming and include low cloud point nonionic surfactants and mixtures of higher foaming surfactants with low cloud point nonionic surfactants which act as suds suppresser therefore.

In particular, alkyl polyglucoside surfactants have been found to be particularly useful. Such surfactants can be utilized in the cleaning composition in amounts of about 0.10 to 6.0 weight percent, preferably 1.0 to 5.0 weight percent, and most preferably 2.0 to 3.0 weight percent of the cleaning composition.

In making use of the cleaning composition for cleaning soil from cooking related surfaces, the cleaning composition is applied to a surface or item to be cleaned by, for example, spraying, dipping, pouring, brushing, etc. The cleaning composition is allowed to remain on the surface for a period of time. Typically, the cleaning composition can be applied to the surface to be cleaned and left to stand in contact with the surface for a period of about 20-200 minutes. The composition is then removed from the surface along with the soil by, for example, washing or flushing with water. Washing can occur, for instance, in an automatic dishwasher, by manual action, spraying or dipping to remove the cleaning composition and the softened cooking residue or soil. In one embodiment, the surface can be heated to about 100°-400° F. for about 20-60 minutes after the cleaning composition has been applied to the surface. Such heating can occur by heating the surface or object itself or by placing the object in an oven or the like. Likewise then, washing in an automatic dishwasher, manual washing, spraying, dipping, etc. can be utilized to remove the cleaning composition and the softened cooking residue or soil. Such use of the cleaning composition does not produce harmful vapors or odors. The cleaning composition also exhibits minimal or no corrosive activity towards the surface.

### EXAMPLES

In preparing the inventive cleaning compositions as examples, the following procedure has been followed: hot tap water of 140°-160° F. is placed in a mixing vessel. Next, veegum granules are added with stirring. The solution is stirred for approximately 30 minutes to completely hydrate the veegum granules. After such hydration of the veegum granules, alkyl polyglucoside surfactant, 2-methyl benzotriazole and glycerin are added and stirred until uniform. The sodium metasilicate pentehydrate is then added. The solution increases in viscosity and the rate of stirring is increased to a prevortex without formation of a vortex. Additionally, the potassium hydroxide is added and thickening is observed by disappearance of the prevortex. Stirring is increased for approximately five minutes until a uniform mixture is obtained. The solution is then allowed to cool to room temperature without additional cooling.

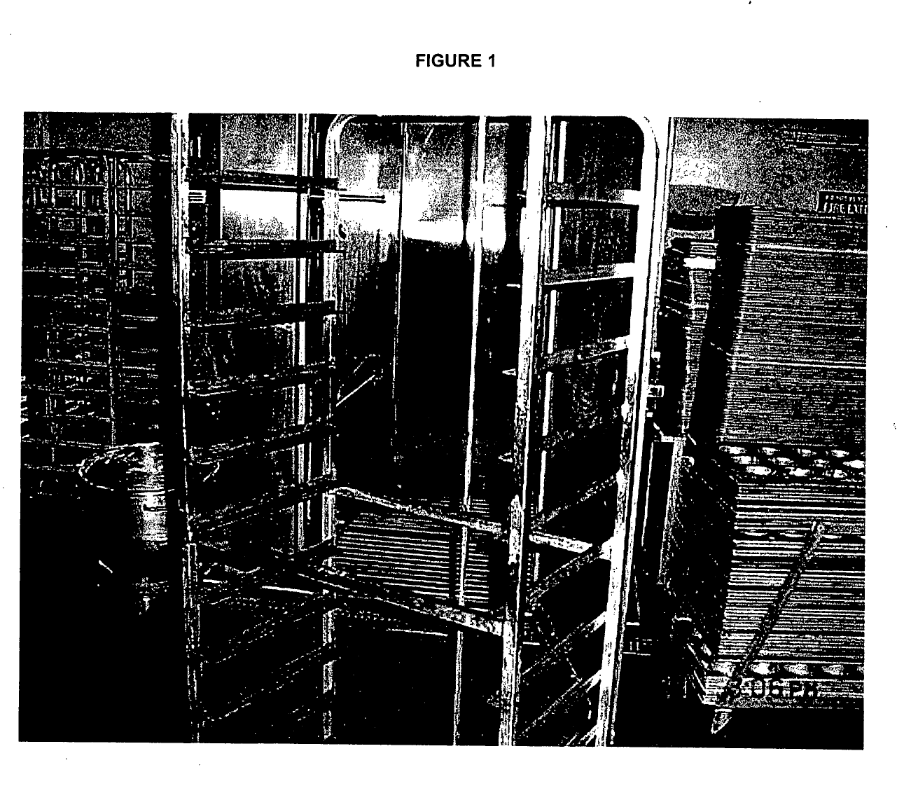

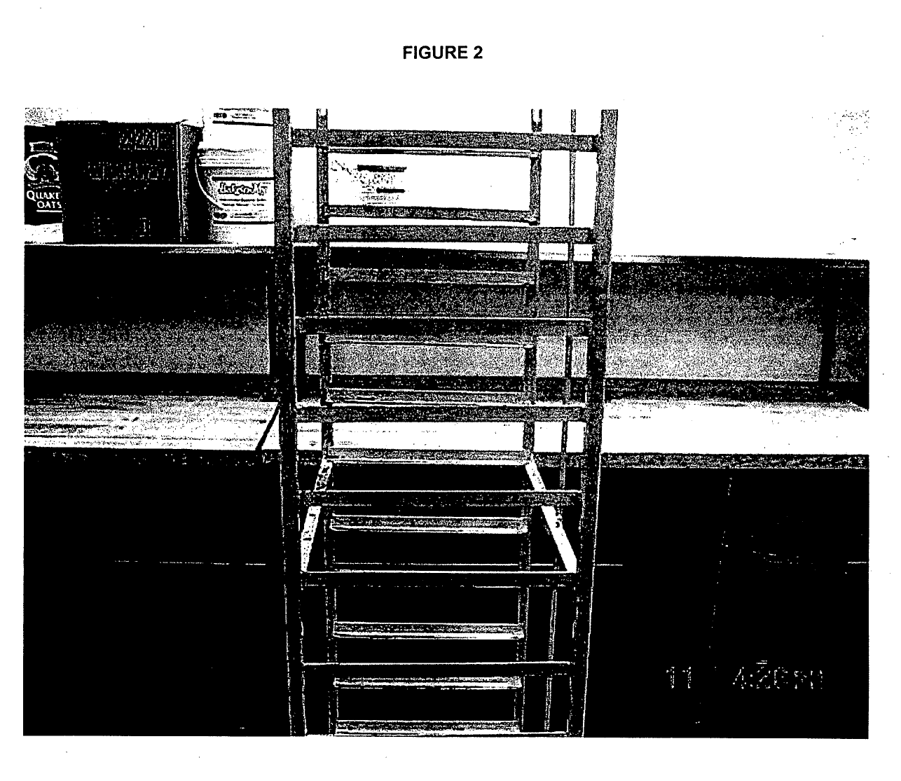

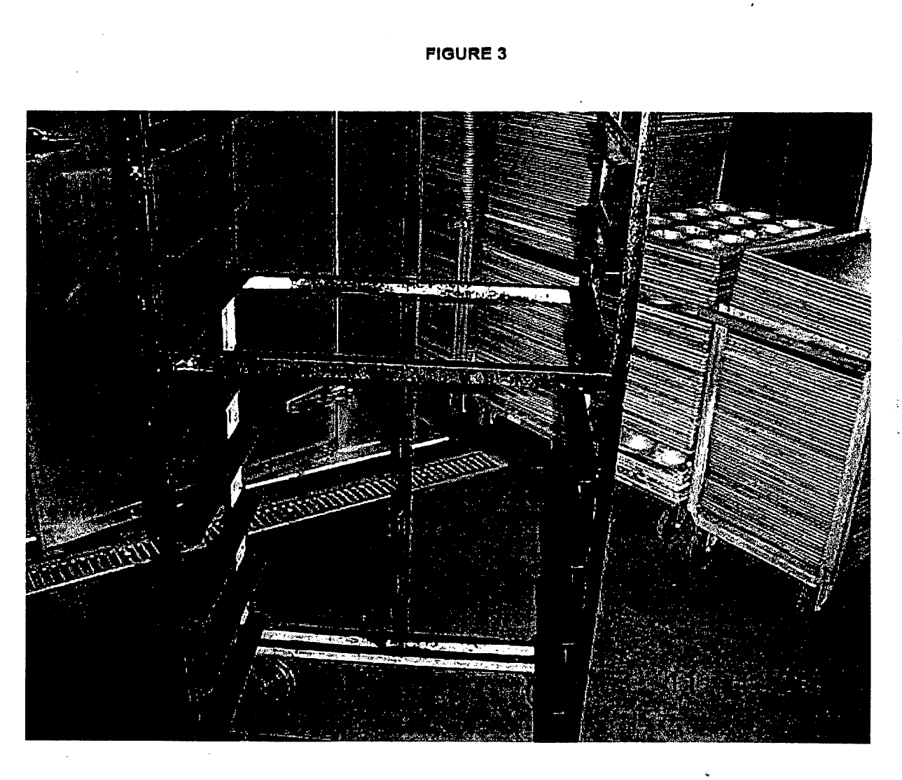

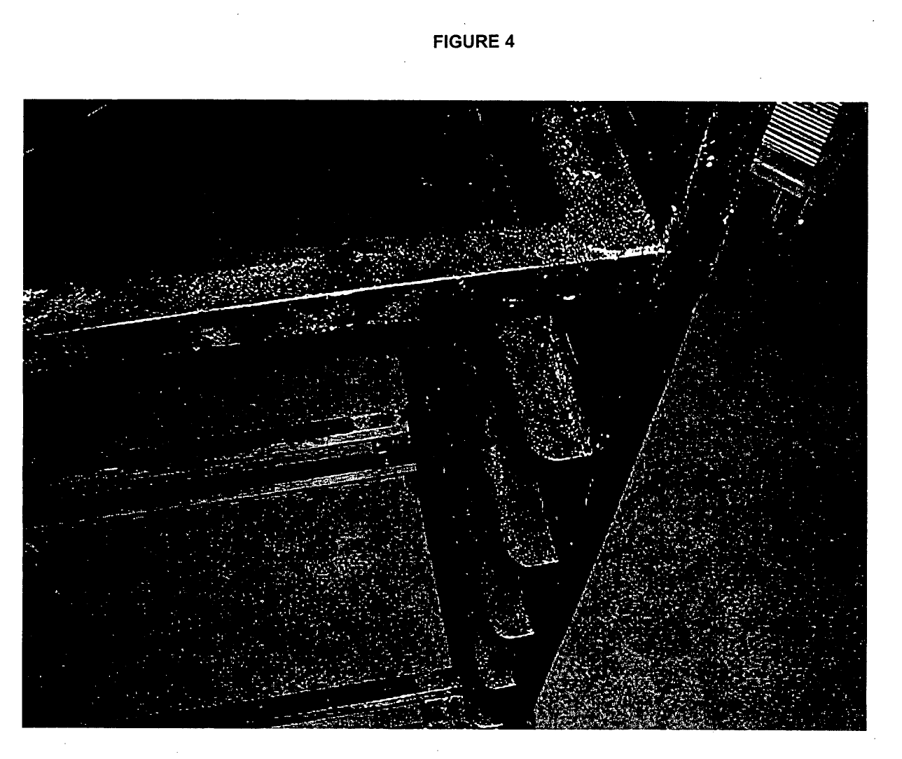

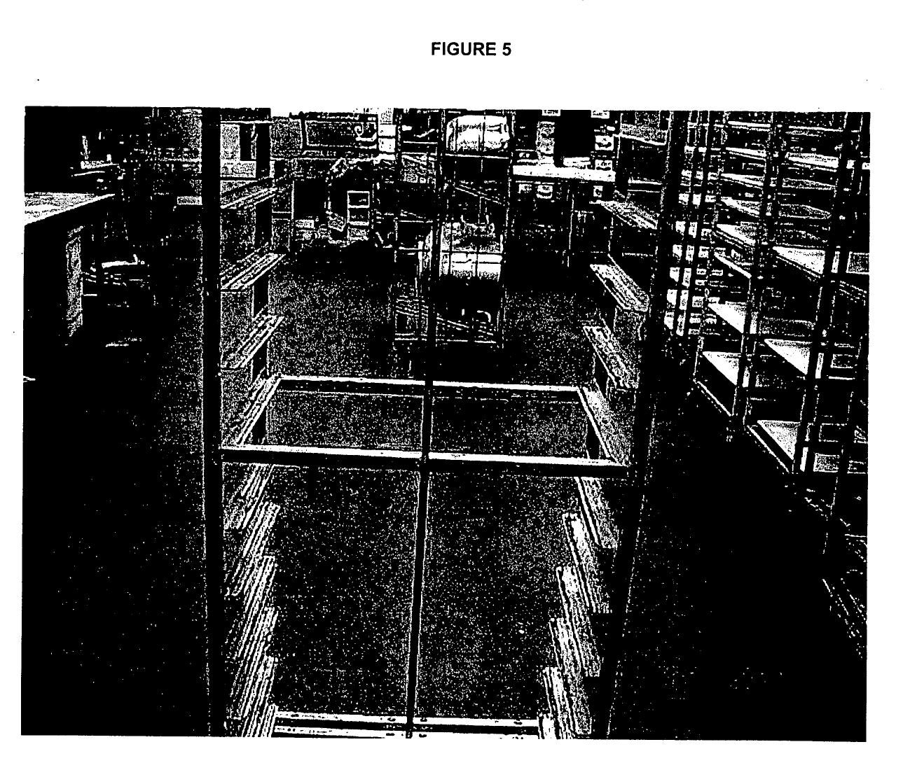

In evaluating the inventive composition in removal of soil, various approaches were utilized. Initially, heavily soiled bakery carts utilized in institutional environments were utilized to evaluate the inventive compositions. Examples of these bakery carts can be found in FIGS. 1, 3 and 4. The composition of the present invention was typically sprayed or brushed onto such carts. The carts were then placed in an oven at about 200′-400° F. for approximately 20-60 minutes. The bakery carts were then removed and placed in an automatic washer for approximately five minutes to remove the softened cooking residues. Examples of the cleaned bakery carts can be found in FIGS. 2 and 5.

It is important to note that any suitable cleaning method known to one of ordinary skill in the art can be utilized for the final washing stage of the inventive method whereby the inventive composition is utilized. For instance, brushing, scrubbing, high-pressure washers or handwashing with sponge and soapy water all proved to be effective in the present method utilizing cleaning composition.

The following cleaning compositions were prepared and applied to bakery carts or pieces thereof. Such carts were utilized for evaluations in Examples I-IV.

### Example I

| | P0477W104-1 | | P0477W104-2 | |
|---|---|---|---|---|
| | | Wt. For | | Wt. For |
| Material Description | Wt. % | 250 g. | Wt. % | 250 g. |
| Deionized Water | 55.00 | 137.50 | 30.00 | 75.00 |
| Sodium Metasilicate Pentahydrate | 10.00 | 25.00 | 10.00 | 25.00 |
| Alkyl Polyglucoside Surfactant | 2.00 | 5.00 | 2.00 | 5.00 |
| Sodium Xylene Sulfonate, 30% | 5.00 | 12.50 | 5.00 | 12.50 |
| Sorbitol | 3.00 | 7.50 | 3.00 | 7.50 |
| Glycerine | 25.00 | 62.50 | 50.00 | 125.00 |
| Totals: | 100.00 | 250.00 | 100.00 | 250.00 |
| | P0477W104-3 | | P0477W104-4 | |
| | | Wt. For | | Wt. For |
| Material Description | Wt. % | 250 g. | Wt. % | 250 g. |
| Deionized Water | 50.00 | 125.00 | 50.00 | 125.00 |
| Sodium Metasilicate Pentahydrate | 10.00 | 25.00 | 10.00 | 25.00 |
| Sodium Xylene Sulfonate, 30% | 5.00 | 12.50 | 5.00 | 12.50 |
| Sorbitol | 3.00 | 7.50 | 3.00 | 7.50 |
| Potassim Hydroxide, 45% | 5.00 | 12.50 | 5.00 | 12.50 |
| Oleic Acid | 2.00 | 5.00 | | |
| Steric Acid | | | 2.00 | 5.00 |
| Glycerine | 25.00 | 62.50 | 25.00 | 62.50 |
| Totals: | 100.00 | 250.00 | 100.00 | 250.00 |

The ingredients were added in the order listed. After the addition of each ingredient, the solution was stirred until monogeneous, before the addition of the next ingredient.

| | |
|---|---|
| P0477W104-1 | Wetted and cleaned in oven at 400 F. |
| P0477W104-2 | Only slight wetting but far better in cleaning than 104-1. |
| P0477W104-3 | Acid did not go into solution. |
| P0477W104-4 | Acid did not go into solution. |

### Example II

| | P0477W105-1 | | P0477W105-2 | |
|---|---|---|---|---|
| | | Wt. For | | Wt. For |
| Material Description | Wt. % | 1,000 g. | Wt. % | 1,000 g. |
| Deionized Water | 28.50 | 285.00 | 27.00 | 270.00 |
| Sodium Metasilicate | 10.00 | 100.00 | 10.00 | 100.00 |
| Pentahydrate | | | | |
| Alkyl Polyglucoside | 2.00 | 20.00 | 2.00 | 20.00 |
| Surfactant | | | | |
| Sodium Xylene Sulfonate, | 5.00 | 50.00 | 5.00 | 50.00 |
| 30% | | | | |
| Sorbitol | 3.00 | 30.00 | 3.00 | 30.00 |
| Elementis EW | 1.50 | 15.00 | 3.00 | 30.00 |
| Glycerine | 50.00 | 500.00 | 50.00 | 500.00 |
| Totals: | 100.00 | 1,000.00 | 100.00 | 1,000.00 |
| | P0477W105-3 | | P0477W105-4 | |
| | | Wt. For | | Wt. For |
| Material Description | Wt. % | 1,000 g. | Wt. % | 1,000 g. |
| Deionized Water | 27.00 | 270.00 | 28.50 | 285.00 |
| Sodium Metasilicate | 10.00 | 100.00 | 10.00 | 100.00 |
| Pentahydrate | | | | |
| Alkyl Polyglucoside | 2.00 | 20.00 | 2.00 | 20.00 |
| Surfactant | | | | |
| Sodium Xylene Sulfonate, | 5.00 | 50.00 | 5.00 | 50.00 |
| 30% | | | | |
| Sorbitol | 3.00 | 30.00 | 3.00 | 30.00 |
| Veegum Granules | 3.00 | 30.00 | 1.50 | 15.00 |
| Glycerine | 50.00 | 500.00 | 50.00 | 500.00 |
| Totals: | 100.00 | 1,000.00 | 100.00 | 1,000.00 |

| | P0477W105-5 | |
|---|---|---|
| | | Wt. For |
| Material Description | Wt. % | 1,000 g. |
| Deionized Water | 27.00 | 270.00 |
| Sodium Metasilicate Pentahydrate | 10.00 | 100.00 |
| Alkyl Polyglucoside Surfactant | 2.00 | 20.00 |
| Sodium Xylene Sulfonate, 30% | 5.00 | 50.00 |
| Sorbitol | 3.00 | 30.00 |
| Veegum Granules | 3.00 | 30.00 |
| Glycerine | 50.00 | 500.00 |
| Totals: | 100.00 | 1,000.00 |

The ingredients were added in the order listed. After the addition of each ingredient, the solution was stirred until monogeneous, before the addition of the next ingredient.

| | |
|---|---|
| P0477W105-1 | Product was thin but cleaned very well. |
| | Glycerine was added with the water to aid |
| | in stirring. |
| P0477W105-2 | Additional Clay only slightly increased |
| | viscosity. Clay needs to be at least |
| | partially hydrated for thickening to occur |
| | and before the addition of the glycerine. |
| | Product was still too thin and ran on a |
| | vertical surface. |
| P0477W105-3 | 105-2 was repeated using hot water. No |
| | noticable differences between −2 and −3. |
| P0477W105-4 | Too thin. |
| P0477W105-5 | Too thin. |

### Example III

| | P0477W106-1 | | P0477W106-2 | |
|---|---|---|---|---|
| | | Wt. For | | Wt. For |
| Material Description | Wt. % | 1,000 g. | Wt. % | 1,000 g. |
| Deionized Water | 43.70 | 437.00 | 43.20 | 432.00 |
| Veegum Granules | 3.00 | 30.00 | 4.00 | 40.00 |
| Potassium Hydroxide, 45% | 4.50 | 45.00 | 4.50 | 45.00 |
| Sodium Metasilicate | 3.00 | 30.00 | 3.00 | 30.00 |
| Pentahydrate | | | | |
| Alkyl Polyglucoside | 2.00 | 20.00 | 2.00 | 20.00 |
| Surfactant | | | | |
| 2-Methyl Benzotriazol | 0.10 | 1.00 | 0.10 | 1.00 |
| Glycerine | 43.70 | 437.00 | 43.20 | 432.00 |
| Totals: | 100.00 | 1,000.00 | 100.00 | 1,000.00 |

The ingredients were added in the order listed. After the addition of each ingredient, the solution was stirred until homogeneous, before the addition of the next ingredient.

| | |
|---|---|
| P0477W106-1 | Product was thick but still had slight sag at RT. |
| | Soiled bar was dipped into product and placed in a 400 F. |
| | oven for 20 minutes. Cleaning was excellent. |
| P0477W106-2 | Product was thick had no sag at RT. Soiled bar |
| | was dipped into product and placed in a 400 F. oven |
| | for 20 minutes. Cleaning was excellent. |
| | Product was difficult to pump. |

### Example IV

| | P0477W107-1 | | P0477W107-2 | |
|---|---|---|---|---|
| | | Wt. For | | Wt. For |
| Material Description | Wt. % | 1,000 g. | Wt. % | 1,000 g. |
| Hot Tap Water | 90.40 | 904.00 | 45.20 | 452.00 |
| Veegum Granules | 0.00 | 0.00 | 0.00 | 0.00 |
| Potassium Hydroxide, 45% | 4.50 | 45.00 | 4.50 | 45.00 |
| Sodium Metasilicate | 3.00 | 30.00 | 3.00 | 30.00 |
| Pentahydrate | | | | |
| Alkyl Polyglucoside | 2.00 | 20.00 | 2.00 | 20.00 |
| Surfactant | | | | |
| 2-Methyl Benzotriazol | 0.10 | 1.00 | 0.10 | 1.00 |
| Glycerine | | 0.00 | 45.20 | 452.00 |
| Totals: | 100.00 | 1,000.00 | 100.00 | 1,000.00 |
| | P0477W107-3 | | P0477W107-4 | |
| | | Wt. For | | Wt. For |
| Material Description | Wt. % | 1,000 g. | Wt. % | 1,000 g. |
| Hot Tap Water | 44.70 | 447.00 | 44.20 | 442.00 |
| Veegum Granules | 1.00 | 10.00 | 2.00 | 20.00 |
| Potassium Hydroxide, 45% | 4.50 | 45.00 | 4.50 | 45.00 |
| Sodium Metasilicate | 3.00 | 30.00 | 3.00 | 30.00 |
| Pentahydrate | | | | |
| Alkyl Polyglucoside | 2.00 | 20.00 | 2.00 | 20.00 |
| Surfactant | | | | |
| 2-Methyl Benzotriazol | 0.10 | 1.00 | 0.10 | 1.00 |
| Glycerine | 44.70 | 447.00 | 44.20 | 442.00 |
| Totals: | 100.00 | 1,000.00 | 100.00 | 1,000.00 |

P0477W107-5

| | | Wt. For |
|---|---|---|
| Material Description | Wt. % | 1,000 g. |
| Hot Tap Water | 43.70 | 437.00 |
| Veegum Granules | 3.00 | 30.00 |
| Potassium Hydroxide, 45% | 4.50 | 45.00 |
| Sodium Metasilicate Pentahydrate | 3.00 | 30.00 |
| Alkyl Polyglucoside Surfactant | 2.00 | 20.00 |
| 2-Methyl Benzotriazol | 0.10 | 1.00 |
| Glycerine | 43.70 | 437.00 |
| Totals: | 100.00 | 1,000.00 |

The ingredients were added in the order listed. After the addition of each ingredient, the solution was stirred until monogeneous, before the addition of the next ingredient.

A soiled bar was sprayed with product and placed in a 400 F oven for 20 minutes.

| | |
|---|---|
| P0477W107-1 | Cleaning was poor. |
| P0477W107-2 | Cleaning much better than W107-1. |
| P0477W107-3 | Excellent cleaning with nearly total removal of the soil. |
| P0477W107-4 | Excellent cleaning with nearly total removal of the soil. |
| P0477W107-5 | Excellent cleaning with nearly total removal of the soil. |

### Example V-VII

For additional experimentation in Examples V-VII, stainless steel panels were utilized, such panels were prepared utilizing the following soil composition and procedure prior to evaluation of the cleaning composition:

Standard Soil

| Material Description | Wt. % |
|---|---|
| Lard | 44.000 |
| Canola Oil | |
| Crisco-Oil | 44.000 |
| Crisco-Solid | |
| Flour | 6.000 |
| Dried Milk | 6.000 |
| Total | 100.000 |

The ingredients were added in the order listed. After the addition of each ingredient, the solution was stirred until homogeneous, before the addition of the next ingredient.

For testing, the soils were brushed onto stainless steel sheets and baked overnight at 350 F and 400 F. The resulting soil closely approximated the baked-on, burned-on soils encountered on cooking related surfaces.

### Example V

Formulation:

| | W020-1 | W020-2 |
|---|---|---|
| Material Description | Wt. % | Wt. % |
| Glycerine | 95.2 | |
| Propylene Glycol | | 95.25 |
| Potassium Hydroxide Pellets | 4.75 | 4.75 |
| Total: | 100.000 | 100.000 |

The ingredients were stirred with heating to 70°-100° C. The solutions were transferred to plastic bottles after cooling.
Ten drops of each solution were placed on a soiled panel and placed in an oven at 350° F. for 10 minutes.

After 10 minutes the solutions were washed from the soiled panels.

| | |
|---|---|
| W20-1 | Solution did not wet the soil but the spot was wet after heating |
| | in the oven and the soil was easily removed with hot tap water. |
| W20-2 | Solution wetted the soil but the spot was dry but the soil |
| | was easily removed with hot water. |

### Example VI

Formulation:

| | W027-1 | W027-2 | W027-3 | W027-4 |
|---|---|---|---|---|
| Material Description | Wt. % | Wt. % | Wt. % | Wt. % |
| Glycerine | 100.000 | 99.000 | 98.000 | 97.000 |
| Potassium Hydroxide | 0.000 | 1.000 | 2.000 | 3.000 |
| (Pellets) | | | | |
| Total: | 100.000 | 100.000 | 100.000 | 100.000 |
| | W027-1 | W027-2 | W027-3 | W027-4 |
| Material Description | Wt. % | Wt. % | Wt. % | Wt. % |
| Glycerine | 96.000 | 95.000 | 94.000 | 93.000 |
| Potassium Hydroxide | 4.000 | 5.000 | 6.000 | 7.000 |
| (Pellets) | | | | |
| Total: | 100.000 | 100.000 | 100.000 | 100.000 |

| | W027-9 | W027-10 | W027-11 |
|---|---|---|---|
| Material Description | Wt. % | Wt. % | Wt. % |
| Glycerine | 92.000 | 91.000 | 90.000 |
| Potassium Hydroxide | 8.000 | 9.000 | 10.000 |
| (Pellets) | | | |
| Total: | 100.000 | 100.000 | 100.000 |

| | 2 drops of formula on | |
|---|---|---|
| | Soil at 350 F. for 20 | 2 drops of formula on Soil |
| Formula | minutes | at 200 F. for 20 minutes |
| W027-1 | No Soil Removal | No Soil Removal |
| W027-2 | Complete Soil Removal | No Soil Removal |
| W027-3 | Complete Soil Removal | No Soil Removal |
| W027-4 | Complete Soil Removal | No Soil Removal |
| W027-5 | Complete Soil Removal | No Soil Removal |
| W027-6 | Complete Soil Removal | No Soil Removal |
| W027-7 | Complete Soil Removal | No Soil Removal |
| W027-8 | Complete Soil Removal | No Soil Removal |
| W027-9 | Complete Soil Removal | No Soil Removal |
| W027-10 | Complete Soil Removal | No Soil Removal |
| W027-11 | Complete Soil Removal | No Soil Removal |

### Example VII

Formulation:

| | P0599W034-1 | | |
|---|---|---|---|
| | | Wt. For | P0599W034-2 |
| Material Description | Wt. % | 1,000 g. | Wt. % |
| Hot Tap Water | 89.90 | 899.00 | 89.40 |
| Veegum Granules | 0.50 | 5.00 | 1.00 |
| Potassium Hydroxide, 45% | 4.50 | 45.00 | 4.50 |
| Sodium Metasilicate | 3.00 | 30.00 | 3.00 |
| Pentahydrate | | | |
| Alkyl Polyglucoside | 2.00 | 20.00 | 2.00 |
| Surfactant | | | |
| 2-Methyl Benzotriazol | 0.10 | 1.00 | 0.10 |
| Glycerine | 0.00 | 0.00 | 0.00 |
| Totals: | 100.00 | 1,000.00 | 100.00 |
| Viscosity, Spindle #4, 50 rpm, | 20 | | 44 |
| 1 minute: | | | |
| | P0599W034-3 | | |
| | | Wt. For | P0599W034-4 |
| Material Description | Wt. % | 1,000 g. | Wt. % |
| Hot Tap Water | 88.40 | 884.00 | 87.40 |
| Veegum Granules | 2.00 | 20.00 | 3.00 |
| Potassium Hydroxide, 45% | 4.50 | 45.00 | 4.50 |
| Sodium Metasilicate | 3.00 | 30.00 | 3.00 |
| Pentahydrate | | | |
| Alkyl Polyglucoside | 2.00 | 20.00 | 2.00 |
| Surfactant | | | |
| 2-Methyl Benzotriazol | 0.10 | 1.00 | 0.10 |
| Glycerine | 0.00 | 0.00 | 0.00 |
| Totals: | 100.00 | 1,000.00 | 100.00 |
| Viscosity, Spindle #4, 50 rpm, | 1,100 | | 3,000 |
| 1 minute: | | | |
| | P0599W034-5 | | |
| | | Wt. For | P0599W034-6 |
| Material Description | Wt. % | 1,000 g. | Wt. % |
| Hot Tap Water | 86.40 | 864.00 | 85.40 |
| Veegum Granules | 4.00 | 40.00 | 5.00 |
| Potassium Hydroxide, 45% | 4.50 | 45.00 | 4.50 |
| Sodium Metasilicate | 3.00 | 30.00 | 3.00 |
| Pentahydrate | | | |
| Alkyl Polyglucoside | 2.00 | 20.00 | 2.00 |
| Surfactant | | | |
| 2-Methyl Benzotriazol | 0.10 | 1.00 | 0.10 |
| Glycerine | 0.00 | 0.00 | 0.00 |
| Totals: | 100.00 | 1,000.00 | 100.00 |
| Viscosity, Spindle #6, 20 rpm, | 5,200 | | 10,000 |
| 1 minute: | | | |
| | P0599W034-7 | | |
| | | Wt. For | P0599W034-8 |
| Material Description | Wt. % | 1,000 g. | Wt. % |
| Hot Tap Water | 84.40 | 844.00 | 83.40 |
| Veegum Granules | 6.00 | 60.00 | 7.00 |
| Potassium Hydroxide, 45% | 4.50 | 45.00 | 4.50 |
| Sodium Metasilicate | 3.00 | 30.00 | 3.00 |
| Pentahydrate | | | |
| Alkyl Polyglucoside | 2.00 | 20.00 | 2.00 |
| Surfactant | | | |
| 2-Methyl Benzotriazol | 0.10 | 1.00 | 0.10 |
| Glycerine | 0.00 | 0.00 | 0.00 |
| Totals: | 100.00 | 1,000.00 | 100.00 |

| | | |
|---|---|---|
| Viscosity, Spindle #6, 10 rpm, | 12,000 | 25,500 |
| 1 minute: | | |

The ingredients were added in the order listed. After the addition of each ingredient, the solution was stirred until homogeneous, before the addition of the next ingredient.

| Formula | Sprayability/Vertical Cling |
|---|---|
| P0599W34-1 | Sprayable but no vertical cling. |
| P0599W34-2 | Sprayable but no vertical cling. |
| P0599W34-3 | Sprayable with slight vertical cling. |
| P0599W34-4 | Sprayable with vertical cling. |
| P0599W34-5 | Sprayable with vertical cling. |
| P0599W34-6 | Sprayable with vertical cling. |
| P0599W34-7 | Sprayable with vertical cling. |
| P0599W34-8 | Sprayable with vertical cling. |

### Example VIII

| | W030-1 | W030-2 | W030-3 |
|---|---|---|---|
| Material Description | Wt. % | Wt. % | Wt. % |
| Glycerine | 100.000 | 99.000 | 97.000 |
| Potassium Hydroxide (Pellets) | 0.000 | 1.000 | 3.000 |
| Total: | 100.000 | 100.000 | 100.000 |
| | W030-4 | W030-5 | W030-6 |
| Material Description | Wt. % | Wt. % | Wt. % |
| Glycerine | 95.000 | 93.000 | 91.000 |
| Potassium Hydroxide (Pellets) | 5.000 | 7.000 | 9.000 |
| Total: | 100.000 | 100.000 | 100.000 |

Test Tubes 1/2 Filled with Formula and Placed in Oven Overnight with an Aluminum Strip to Test for Al Corrosivity.

| | |
|---|---|
| W030-1 | No Gas Evolution or discoloration of Al. |
| W030-2 | No Gas Evolution or discoloration of Al. |
| W030-3 | No Gas Evolution or discoloration of Al. |
| W030-4 | No Gas Evolution or discoloration of Al. |
| W030-5 | No Gas Evolution or discoloration of Al. |
| W030-6 | No Gas Evolution or discoloration of Al. |

### Example IX

Aluminum weighing dishes were placed in 400 ml beakers and the various formulas were sprayed into the beakers, completely covering the aluminum dishes. After standing overnight the aluminum weighing dishes were removed and rinsed with warm running water and evaluated.

| Formula | |
|---|---|
| Mr. Muscle | Completely Dissolved the Aluminum Dish |
| Easy Off Heavy | Completely Dissolved the Aluminum Dish |
| Duty | |
| Easy Off Fume | Discolored the Aluminum Dish |
| Free | |
| P0477W104-3 of | Aluminum was still bright and shiny |
| Example 1 | |

These examples represent a few of the possible formulations and methods of preparation and use of the inventive composition. While the principles of this invention have been described in connection with specific embodiments, it should be understood clearly that these descriptions are made only by way of example and are not intended to limit the scope of the inventive composition nor the inventive method.

1. A composition for cleaning soil from a cooking related surface comprising:
a) a solvent system comprising at least one polyhydric alcohol;
b) at least one inorganic alkaline salt.

2. The composition of claim 1 wherein the solvent system is about 0.50 to 98.5 weight percent of the composition.

3. The composition of claim 2 wherein the solvent system is about 20.0 to 80.0 weight percent of the composition.

4. The composition of claim 2 wherein the solvent system is about 40.0 to 50.0 weight percent of the composition.

5. The composition of claim 1 wherein the polyhydric alcohol is an alkane polyol having from 2 to 6 carbon atoms and from 2-3 hydroxyls in the molecule.

6. The composition of claim 1 wherein the solvent system further includes water.

7. The composition of claim 1 wherein the polyhydric alcohol is selected from the group consisting of ethylene glycol, propylene glycol, dipropylene glycol, glycerin, 1,2-Butanediol, 1,3-Butanediol, 1,4-Butanediol, 2,3-Butanediol, 1,2-Propanediol, 1,5-Pentanediol, meso-erythritol, neopentyl glycol, pentaerythritol, and blends thereof.

8. The composition of claim 1 wherein the inorganic alkaline salt is about 0.10 to 10 weight percent of the composition.

9. The composition of claim 8 wherein the inorganic alkaline salt is about 0.10 to 3.0 weight percent of the composition.

10. The composition of claim 8 wherein the inorganic alkaline salt is about 1.0 to 2.0 weight percent of the composition.

11. The composition of claim 1 wherein the inorganic alkaline salt are selected from the group consisting of lithium carbonate, potassium carbonate, sodium carbonate, lithium hydroxide, potassium hydroxide, sodium hydroxide, lithium silicates, sodium silicates, potassium silicates, lithium phosphates in all forms, sodium phosphates, potassium phosphates, and combinations thereof.

12. The composition of claim 1 further comprising a thickener.

13. The composition of claim 1 further comprising a corrosion-inhibition system.

14. A method of cleaning soil from cooking related surfaces comprising:
a) applying a cleaning composition to said surface, the cleaning composition comprising a solvent system and at least one inorganic alkaline salt, the solvent system including at least one polyhydric alcohol;
b) allowing the cleaning composition to remain on said surface for a period of time; and
c) removing said composition from the surface along with the soil.

15. The method of claim 14 further comprising heating the surface for about 20 to 60 minutes after applying the cleaning composition to said surface.

16. The method of claim 15 wherein the surface is heated to about 100 to 400° F.

17. The method of claim 1 further wherein the removing step comprises washing said surface.

18. The method of claim 14 wherein the composition is allowed to remain on the surface for about 20 to 200 minutes.

19. A composition for cleaning soil from cooking related surfaces comprising:
a) a solvent system comprising at least one polyhydric alcohol;
b) at least one inorganic alkaline salt,
wherein said composition effectively removes a significant amount of soil from a cooking related surface.

20. The composition of claim 19 wherein the cleaning composition is non-corrosive.
